(19) United States
(12) Patent Application Publication
(10) Pub. No.: US 2009/0327104 A1
(43) Pub. Date: Dec. 31, 2009

(54) SYSTEM FOR TRACKING AND PROVIDING VISIBILITY OF ORIGIN OF FOOD ELEMENTS

(76) Inventors: Craig C. Sanders, Chapin, SC (US); Jeffrey Randall Grissom, Wolde, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/491,684

(22) Filed: Jun. 25, 2009

Related U.S. Application Data
(60) Provisional application No. 61/075,375, filed on Jun. 25, 2008.

(51) Int. Cl. G06Q 10/00

(52) U.S. Cl. 705/28

(57) ABSTRACT

A method and apparatus which facilitates the application of GPS or other location-specific information directly to discrete units of food products. In one embodiment, a tractor pulls a harvesting apparatus which facilitates not only the harvesting and packaging of discrete food product units but also the application of location-specific time-stamped data directly onto the food product units or their packaging. Food product units planted in substantially parallel rows are cut from the ground by cutter personnel walking behind the moving apparatus, whereupon the cutters pass the food product to a cut product station atop the harvesting apparatus. The food product units are picked and packed by packer personnel situated atop the harvesting apparatus; during this step indicia is applied to the packaging (or the food product) which provides the association of GPS or other location-specific information with the discrete units of food products.

### CROSS-REFERENCE TO RELATED APPLICATIONS

This application is a nonprovisional patent application, which claims priority from Provisional Application No. 61/075,375, filed Jun. 25, 2008, said provisional application being incorporated herein by reference in its entirety.

### BACKGROUND OF THE INVENTION

There is a known need in the art to provide ways to trace back the source of produce or other food sold to the public, such as in the event certain food is contaminated. Such information can be used to determine whether certain food can be safely consumed, or must be discarded.

Labels have been used to apply source-related data on products. Current information known to be placed on food labels includes ranch, block and/or lot numbers; this information may be said to be in a “coded” format in that cannot be readily interpreted. As an example, although a lot number may be associated with a particular item of produce, often the only way to track back the source of such produce is by using the records of those involved in the produce supply chain, which is often held on the legacy systems of many different supply chain entities.

The extent to which current label or direct-printed information can be tracked is limited in the known food supply chain. In the known prior art, fresh commodity produce is not sold with an identifier readily visible to the consumer. If the consumer has questions or the product needs to be traced for regulatory purposes, the process requires multiple steps of communication and decoding of the Ranch, Block and or lot numbers. This process relies on manual recording of data such as Ranch, Block and/or lot numbers and subsequent application of same to master containers. Such data on the containers are generally not available to the consumers; as noted above it is often held on the legacy systems of many different supply chain entities, with no coordination between same.

Thus, disadvantages are apparent. It may be understood that currently, raw commodity produce once removed from the master container (done before the consumer has visibility) has insufficient trace back information available to consumers or regulatory officials. The method to remove suspect fresh produce relies on anything bought during a period. This method relies on receiving data and does not correlate 100% of product. It utilizes “coded” information that eventually relates back to ranch, lot, or block numbers. This method of decoding is time intensive and requires a long chain of communication and accounting to eventually lead to the actual producer. In addition to the time involved there is not 100% accountability at each step leading to much wider recalls than needed.

It may thus be seen that there are many deficiencies of this system. One deficiency is the time involved in decipher and multiple communications from retailer through actual farmer.

Another deficiency is that the system changes over time as block and lot numbers are assigned and reassigned over time.

Another deficiency is that accuracy is often only identifiable to a general growing area and requires large recalls.

Another deficiency is that the codes used are not universal and have no standard.

Another deficiency is that the information often has many layers of decode as the multiple handlers use various methods of lot identification.

Another deficiency is that this system also does not provide a readably available source for country of origin identification. In the case of quarantine or local embargo it becomes an arduous task to audit.

Therefore, it may be seen that there is a need in the art to overcome at least the above deficiencies.

### BRIEF SUMMARY OF THE INVENTION

The present concepts relate to providing detailed and date-stamped “non-coded” GPS or other location-specific data, with such detail so as to allow an end user to view a label on a food product (e.g., a head of lettuce) and to use particularly specific GPS coordinates on the label to determine within a very close proximity in date, time and location (down to a small harvest area within the field) where the food was grown and harvested. This would allow the end user to simply access an online internet application such as Google and to submit longitude and latitude data, thus better understanding the particular growing location (via a map showing state, country, etc). As the material is time-stamped, the time of harvesting may also be visible to the end user. This would not only provide immediate information and comfort to consumers but could also be used by the appropriate authorities in the event of contamination concerns. This provides a global standard with immediate resolution not requiring the decipher process.

The present concepts include a method for providing source indication for food products harvested at a growing location, distributed through a distribution network, and sold at multiple sales locations to a corresponding plurality of buyers, the method comprising the steps of: A) harvesting a plurality of discrete food products from a corresponding plurality of known geographic locations, each differing from the other but identifiable by a set of location specific geographic coordinates based on a common geographic coordinate system; and B) associating the geographic coordinates with the plurality of food products in a manner such that the coordinates may be read by each of the buyers, in order to determine the growing location of each of the plurality of food products. A specific method could include the above method wherein in Step “A”, the harvesting of the plurality of discrete food products from a corresponding plurality of different known geographic locations is done at a corresponding plurality of known but different harvesting times, and wherein in Step “B”, the known harvesting times are associated along with the geographic coordinates with the plurality of food products in a manner such that the times and coordinates may be read by each of the buyers, in order to determine the harvesting location and time of each of the plurality of food products.

The present concepts also include a method for providing source indication for food products harvested at a growing location including a growing space, distributed through a distribution network, and sold at multiple sales locations to corresponding multiple buyers, the method comprising the steps of: A) providing a harvesting apparatus including a cut product station and at least one printer adjacent the cut product station; B) moving the harvesting apparatus from a known geographic location at a known speed and direction; C) tracking the geographic location of the harvesting apparatus; D) defining a two dimensional virtual cut zone adjacent to and moving with the harvesting apparatus, the virtual cut zone being a zone in which at the food products are harvested relative to the harvesting apparatus as the harvesting apparatus is moving, such that the geographic coordinates of the cut zone are known relative to the geographic location of the harvesting apparatus as it moves; E) harvesting the food products from their harvest location while in the virtual cut zone as the harvesting apparatus is moving and as the location of the virtual cut zone is known; F) moving the products from the virtual cut zone to the cut product station of the harvesting apparatus; and G) printing, with the printer provided in Step “A”, geographic coordinate related indicia corresponding to the location of the cut zone at the time the food products were harvested, and associating the indicia with the plurality of food products in a manner such that the indicia may be read by each of the buyers, in order to determine the harvest location of each of the plurality of food products.

A more specific method could include the method in the above paragraph, wherein in step “G”, the geographic coordinate related indicia is in the form of longitudinal and latitudinal coordinates printed on the packaging of each of the food products, such that the buyers can use the longitudinal and latitudinal coordinates in determining the harvesting location of the food products. Alternately, the indicia could be printed directly to the food products. Another more specific method could include the method in the above paragraph wherein in step “G”, the “cut to print time”, that being the average time taken from when the food products are harvested to the time their geographic coordinate related indicia is associated therewith, is taken into account.

The present concepts also include a system for providing source indication for food products first harvested at a growing location including a growing space, then distributed through a distribution network, and finally sold at multiple sales locations to corresponding multiple buyers, the system including a tractor for moving at a known speed and direction through the growing space, the tractor including a tractor data device, the tractor location data device configured for tracking location specific geographic coordinates of the tractor as the tractor moves across the growing space; a harvesting apparatus configured to be pulled behind the tractor while the food products are harvested adjacent thereto, the harvesting apparatus including at least one printer configured to print tracking location specific geographic coordinate data associated with the harvest location of the food products, the printing being done in the form of indicia printed on labels configured to be applied to corresponding the food products; and a control device having a data link with the tractor and a data link with the at least one printer, the control device configured to cause the printer to print the indicia such that the labels may be placed upon the food products and the coordinate data may be read by each of the buyers.

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWING(S)

Having thus described the concepts in general terms, reference will now be made to the accompanying drawings, which are not necessarily drawn to scale, and wherein:

FIG. 1 is an illustrative view of a system 10 according to one embodiment of a present invention, which shows a tractor 20 or other motive source used which pulls a harvesting apparatus 30.

FIG. 2 is a step flow chart showing the process used with the system 10 of FIG. 1.

FIG. 3 is a exemplary label 7 including indicia 8 which can be applied to product packaging which provides the application of GPS or other location-specific information directly to discrete units of food products. It may also be understood that the indicia could be applied directly to the packaging by methods known in the art.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Overview of Inventive Concepts

The present inventive concepts overcome deficiencies in the prior art by the use of a method and apparatus for which facilitates the application of GPS or other location-specific information directly to discrete units of food products. In one embodiment this is facilitated by the application of such information to food packaging as the product is harvested and packed in the harvesting field.

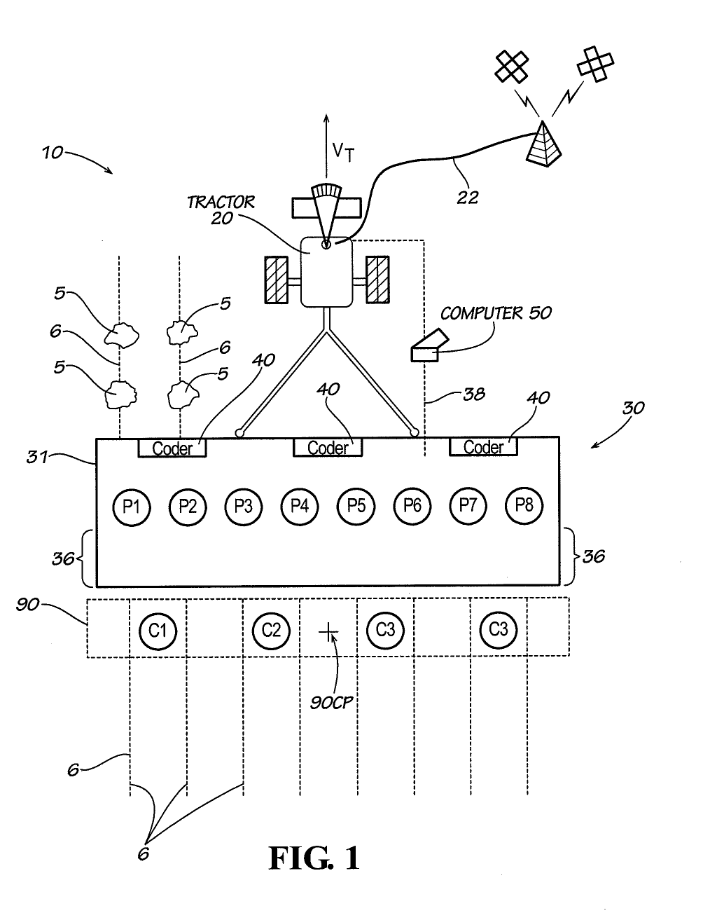

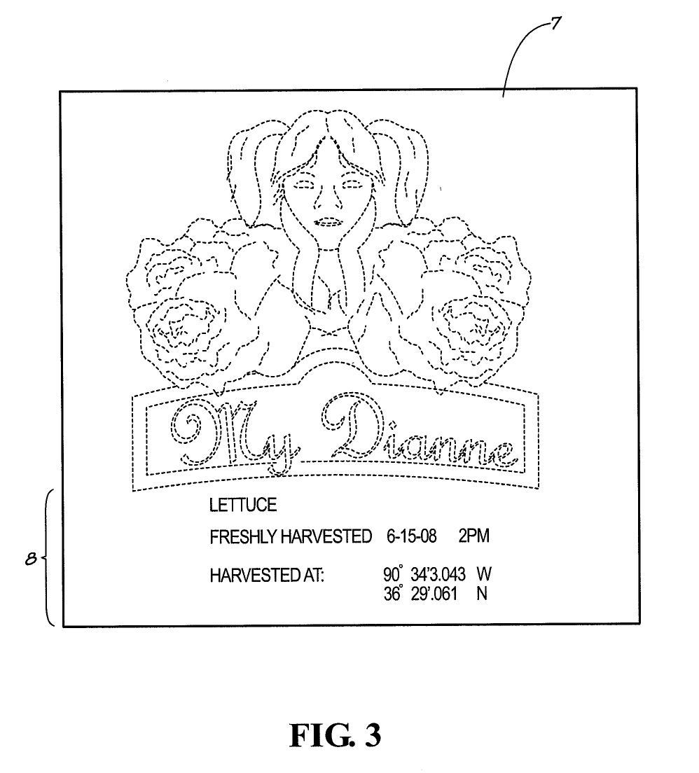

In one embodiment, as shown in FIG. 1, a tractor 20 or other motive source is used which pulls a harvesting apparatus 30. The harvesting apparatus 30 includes a packaging or direct marking feature which facilitates not only the packaging of discrete food product units 5 harvested by the harvesting apparatus 20 but also the application of location-specific time-stamped data 8 (see FIG. 3) directly onto the packaging of the discrete food product units 5, or directly onto the food product.

Food product units 5 planted in substantially parallel rows 6 are cut from the ground by cutter personnel (“cutters”) walking behind the moving apparatus 20, whereupon the cutters pass the food product to a cut product station 36 atop the harvesting apparatus 20. The food product units 5 are then picked up and packed by packer personnel (“packers”) situated atop the harvesting apparatus 20; during this packing step indicia is applied to the packaging (and/or directly to the food product) which provides the association of GPS or other location-specific information with the discrete units of food products.

### ELEMENT LIST

Here is an exemplary listing of elements numbered herein:
5 Discrete food product units
6 Food product rows
7 Printed label 7
8 location data portion of label
10 Overall Product Harvesting and Labeling System
20 Tractor
22 tractor location and guidance system
30 Harvesting apparatus
32 Main body portion
36 Cut product station
38 Data connection
40 Coding apparatuses (3 shown)
50. Computer
90 Cut zone
C1-C3 Cutter Stations
P1-P8 Packer Stations

Details of Inventive Concepts

Reference is first made to FIG. 1, which shows an overall product harvesting and labeling system 10 which includes the use of a tractor 20, a harvesting apparatus 30, and a computer 50.

GPS Data Generally

The term “GPS data” should be understood to include data used in conjunction with the Global Positioning System (GPS), a global navigation satellite system (GNSS) developed by the United States Department of Defense. This data includes latitude, longitude, and if necessary, geodesic height.

The term “GPS data” should be understood to be included within the more general category of “location specific geographic coordinates based on a geographic coordinate system”.

Tractor 20

A conventional tractor 20 is utilized, which has associated therewith a tractor guidance system 22, which supplies relatively accurate GPS data which can be used to guide or otherwise control the tractor. At least a part of this data (in one embodiment, location, ground speed and heading) is made available along a data line 38 which supplies said data to a computer 50 described later.

In one embodiment, the tractor location and guidance system 22 may be such as those shown in U.S. Pat. Nos. 6,691,135 and 6,671,698. The disclosures of these patents are incorporated herein.

It may thus be understood that data is available from the tractor which provides very accurate time-stamped position information. However, it should be understood that other sources of such time-stamped position information could also be used; for example instead of receiving such data from the tractor, time-stamped position information could be used from some other source, such as a GPS unit dedicated to the harvesting apparatus. Nevertheless, in the remaining discussion data received from the tractor will be used as an example.

Harvesting Apparatus 30

The tractor 20 pulls the harvesting apparatus 30 behind it, traveling at tractor speed V_{T}, which may generally in the 2 MPH range, although other speeds may obviously be used depending on conditions. Whatever the speed, it is factored into calculations described below.

The tractor 20 and harvesting apparatus 30 move together atop terrain which includes discrete food product units 5 planted in substantially parallel rows 6. Discrete units could include 1 head of lettuce, 1 head of cabbage, 1 head of broccoli, etc.

The harvesting apparatus 30 includes a main body portion 31, which includes coder apparatuses 40 (three are shown although more or less may be used), packer stations P1-P8, and a cut product station 36. Virtual cutter stations C1-C4 associated with the harvesting apparatus 30 trail behind the harvesting machine.

Coder Apparatuses 40

The output of the coder apparatuses 40 will be described in more detail elsewhere in this application, but generally described they facilitate the application of the GPS data or other location-specific information directly to the discrete units of food products. In the contemplated embodiment this is done either by the use of a printed label, or by the use of direct printing to the product packaging. They are all connected via network to the computer 50 via data line 38. This network can be as known in the art, and can be hard-wired or wireless. In the preferred embodiment the computer 50 is mounted to the frame of the harvesting apparatus although it is shown spaced therefrom in an illustrative manner in the drawing.

It should be understood that the coder apparatuses in one embodiment operate independently on an “on demand” basis; they stand prepared to print data upon activation by the packer. Typically this can be when the packers are ready to pack and/or label the product.

Packer Stations P1-P8

In the embodiment shown, there are eight (8) packer stations P1-P8, although other numbers of packer stations may be used.

These packer stations are typically occupied by packers (not shown) which are persons which have the task of accepting cut food product units 5 from the cutters and packing the food product units 5. The packer stations are atop the main body portion 31 of the harvesting apparatus 30.

The role of the packers at the packing stations is to pack the cut food products in packaging. It is during this step of packaging that the GPS or other location-specific information is applied directly to the discrete units of food products. This may be done in two different manners: 1) by the creation of labels printed and applied to the packaging, or 2) by the use of direct printing to the packaging which may be done by the use of known printing means which can be used at the same time the packaging is sealed.

Cutter Stations C1-C4

In the embodiment shown, there are four (4) cutter stations C1-C4 associated with the harvesting apparatus 30, although other numbers of cutter stations may be used. These cutter stations C1-C4 are not atop the harvesting apparatus in the embodiment shown; they are “virtual” stations defined by the current process within an overall virtual “cut zone” 90, based on past experience in the field of where the cutters typically operate while performing the cutting process while walking behind the harvesting machine.

The cutter stations C1-C4 move at generally the same speed as the tractor speed V_{T}, at a location which allows the cutters, walking behind the harvesting apparatus 30 while remaining preferably in the cutter stations, to both cut the food product units 5 from their positions along the food product rows 6 (and within the cut zone 90) and place the cut product atop the harvesting device 30 atop the cut product station.

The “cut zone”, being virtual and readily defined as needed, can be of different sizes according to the particular harvesting application. In one embodiment, it is six (6) feet deep in the front-to-back “travel” direction. In the transverse direction it may be sized as needed depending on the number of cutters being used. One exemplary dimension is forty (40) inches per cutter. For the four cutter stations C1-C4 shown, this would translate to a cut zone width of 160 inches (or 13 feet, four inches).

The geometric center point of the cut zone (see 90CP of FIG. 1) is the point to which the specific location data is assigned. Therefore it may be understood that although in fact the GPS data listed on the labels may be very specific in being down to the level of a few inches, in fact a tolerance distance is in existence, in that product listing that specific cut zone center point could have been picked anywhere in the cut zone at that time.

Computer 50

As noted above, relatively accurate GPS data is typically used to guide or otherwise control the tractor. At least a part of this data (in one embodiment, location, ground speed and heading) is made available along a data line 38 which supplies said data to the computer 50 described later.

Therefore in summary the computer 50 then has detailed and ongoing information as to the location of the tractor as a function of time. It may therefore be understood that as the harvesting apparatus 30 is typically towed behind the tractor 20, and the harvesting apparatus is a relatively rigid structure, then through known measurement and calculations the location of the tractor as a function of time can also be determined assuming substantially straight-line operation. As the relative position of the cut zone 90 is also defined as a virtual zone trailing the harvesting machine, then too can the location of the cut zone 90 as a function of time can also be determined.

However, it takes some time for food products cut from the cut zone 90 to be packaged by the packers (where the location-specific time-stamped data is applied to the product packaging). This time will be defined as “cut-to-print” time, and can vary according to a variety of factors, and needs. This cut-to-print time is initially calibrated prior to operation of the system, and recalibrated as needed throughout continued operation. Once the cut-to-print time is known, a data cache may used in or by the computer when determining what location-specific time-stamped data is applied to the product packaging; at the time the data is applied to the packaging, the time which is applied at that point to the packaging will actually reflect the “cut-to-print” time that has since elapsed. In the instance of a 90 second “cut-to-print” time, the labels (or ink) being printed at a given time will reflect a time that is 90 seconds later.

Therefore given the location of the cut zone 90 as a function of time, and knowing the current “cut-to-print” time, the computer 50 is then able to locate the appropriate location-specific time-stamped data and send it to the coders 40, such that labels or direct printing is provided to the packaging which corresponds to the best extent possible a very accurate indication of where a particular product was cut and when.

The term computer 50 is used generally but may be understood by one skilled in the art to include a calculating device that is capable of receiving, processing, storing, and sending data. The computer should have adequate storage capabilities in order to “cache” a suitably large amount of data incoming from various locations to comfortably span the “cut-to-print” time, and should have adequate storage capabilities in order to store the location-specific time-stamped data which is applied to the product packaging.

Said another way, the computer, used appropriately by an operator, can perform:
Automatic calculation of harvest offset versus tractor location
Automatic calculation of harvest offset based on ground speed
Automatic cache of GPS numbers based on coding demand
Manual operator intervention for special events
Manual operator intervention for start of crew and stop of crew
Collection of range of GPS data supporting daily harvest
Collection of range of GPS data supporting lot and blocks
Uploading of all data to internet for storage

Operation

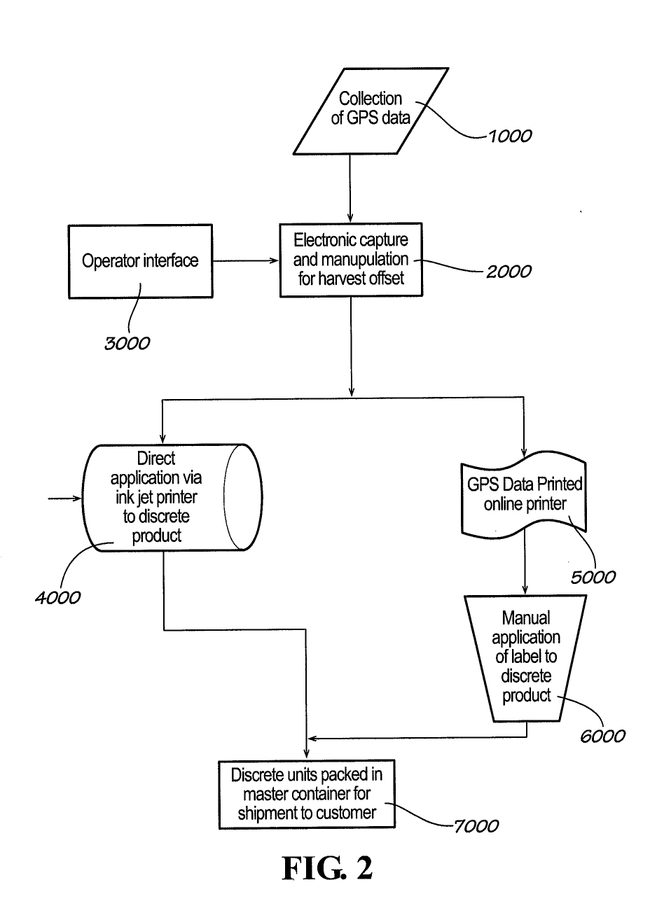

Reference is now made to FIG. 2, which is a step flow chart showing the process used with the system 10 of FIG. 1.

Step 1000—Collection of GPS Data

At step 1000, GPS data is collected relative to the location of the tractor, from the tractor location and guidance system 22.

Step 2000—Electronic Capture and Manipulation for Harvest Offset

This step includes acceptance of data from Step 1000, along with input from an operator, so as to send data to be printed at either steps 4000 or 5000, depending on the application.

At least a portion of data collected at Step 2000 (namely GPS location, ground speed, and bearing) is communicated from the tractor's onboard computer system to the computer 50. In step 2000, the computer 50 (and its operator, providing input from 3000) is responsible for assigning the relevant time-coded GPS location data to the food product units and facilitating the application of such data to the packaging of the food product units. Generally speaking, the computer receives the assigned data to the food product as it is being cut from the virtual cutter stations C1-C4. The GPS location of the tractor is known by the tractor location and guidance system 22; the relative location of the virtual cutter stations C1-C4 relative to the tractor is fixed and can be measured. By knowing the speed of the tractor, which is the same speed as the harvesting apparatus 30, the GPS location of the virtual cutter stations C1-C4 (and the cutting zone 90) as a function of time can be calculated. By estimating the lag time between the time product is cut and the time the data is applied to the packaging (which will vary due to the human element), the data set forth on the label shown in FIG. 3 can be provided.

Step 3000—Operator Interface

This step includes all the ways the operator may affect the operation of the system through interaction with the computer 50, from initial setup, to steady state operation, to exceptional events. It is assumed that the operator will have visual access to the operation of the harvesting apparatus 30.

Other than the interaction with the computer described elsewhere, it may be understood that certain exceptional events may be able to be addressed by the operator. One exceptional event is where the harvesting apparatus 30 may need to pass over a temporary bare spot in growth in a particular row (such as where seed may have run out in the planting operation of a particular row), or has to turn around after the end of a row. The current system includes a “pause and resume” step in this instance. The operator will “pause” the system at the time the last product is packaged (and labeled) before the packers run out of product. At this time data from the tractor is not needed and can be dumped. When the cutting zone 90 of the harvesting apparatus 30 again encounters product (and product can then again be accessed to cut), the system may be “resumed”. At which data from the tractor will again begin to be received as it will be of use.

Another exceptional event is when the harvesting apparatus 30 is only passing over a portion of product (such as would be the case in which the harvesting apparatus 30 is making the last pass along the edge of a field and the width of the harvesting apparatus 30 is greater than the zone being harvested), the cut zone could be modified in the system so that it only covers harvested product and not the bare peripheral area of the field.

Step 4000

Step 4000 is the direct printing of the location data to the packaging by use of an ink jet printer such as known in the art, based on information sent from the computer. In one embodiment this can be done at the same time as a band sealer is used.

Step 5000

Step 5000 takes data sent from the computer and prints the data on a label.

Step 6000

Step 6000 is the step of applying the label (printed at Step 5000) to packaged product.

Step 7000

At this point, the units are packed in a master container for shipment to the customer.

Other Use of Data

Under one inventive concept, a variety of data may be stored as needed for later use. It may be understood that the data accumulated under the current concept may be used or “mined” for a variety of other purposes which could be helpful to anyone in the associated product supply chain.

Conclusion

Thus it may be seen that the present inventive concepts provide an improvement over the prior art by providing a method of openly identifying the source location for growing and harvesting of discrete fresh vegetables and fruits on the individual consumer package utilizing an open GPS address or other suitable location data.

Also provided is a method of live data manipulation that allows for manual adjustment to provide a more defined harvest area for the open GPS address or other suitable location data.

Also provided is an instantaneous trace back system that provides in an English non coded format providing the exact location in the field and date and time information for harvest the general public.

Also provided is an instantaneous country of origin definition in an English non coded format providing the exact location in the field and date and time information for harvest the general public.

Also provided is a method of live discrete product labeling not requiring data storage for future retrieval, and a method of growing and harvest coding requiring no deciphering or decoding.

Also provided is a global and universal non changing format for product identification that can be used anywhere in the world without interpretation.

Also provided is a method of creating a global database of producers utilizing GPS boundaries for definition.

Also provided is the use of a virtual “cut zone” trailing a harvesting machine, in the assignment of time-stamped GPS or other location data identifying the cut location of food products harvested in the field, with this cut zone being adjustable according to harvesting conditions.

In conclusion, it may be seen that the present concepts provide detailed and date-stamped “non-coded” GPS or other location-specific data, with such detail so as to allow an end user to view a label on a food product (e.g., a head of lettuce) and to use particularly specific GPS coordinates on the label to determine within a very close proximity in date, time and location (down to a small harvest area within the field) where the food was grown and harvested. This would allow the end user to simply access an application such as Google to determine the particular growing location. As the material is time-stamped, the time of harvesting may also be visible to the end user. This would not only provide immediate information and comfort to consumers but could also be used by the appropriate authorities in the event of contamination concerns. This provides a global standard with immediate resolution not requiring the decipher process.

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

That which is claimed:

1. A method for providing source indication for food products harvested at a growing location, distributed through a distribution network, and sold at multiple sales locations to a corresponding plurality of buyers, said method comprising the steps of:
A) harvesting a plurality of discrete food products from a corresponding plurality of known geographic locations, each differing from the other but identifiable by a set of location specific geographic coordinates based on a common geographic coordinate system; and
B) associating said geographic coordinates with said plurality of food products in a manner such that said coordinates may be read by each of said buyers, in order to determine said growing location of each of said plurality of food products.

2. The method of claim 1,
wherein in Step “A”, said harvesting of said plurality of discrete food products from a corresponding plurality of different known geographic locations is done at a corresponding plurality of known but different harvesting times, and
wherein in Step “B”, said known harvesting times are associated along with said geographic coordinates with said plurality of food products in a manner such that said times and coordinates may be read by each of said buyers, in order to determine said harvesting location and time of each of said plurality of food products.

3. The method of claim 1,
wherein in Step “B”, said geographic coordinates are associated with said plurality of food products by printing visually-identifiable longitudinal and latitudinal coordinates on the packaging of each of said food products, such that said buyers can read and subsequently use said longitudinal and latitudinal coordinates in determining the harvesting location of said food products.

4. The method of claim 3,
wherein in Step “A”, said plurality of food products are harvested by a food harvesting apparatus in a food growing field, and
wherein in Step “B”, said coordinates are associated with said plurality of food products by printing longitudinal and latitudinal coordinates on the packaging of each of said food products while said food harvesting apparatus is in said food growing field, such that said buyers can use said longitudinal and latitudinal coordinates in determining the harvesting location of said food products.

5. The method of claim 1,
wherein in Step “B”, said geographic coordinates are associated with said plurality of food products by printing visually-identifiable longitudinal and latitudinal coordinates directly on each of said food products, such that said buyers can read and subsequently use said longitudinal and latitudinal coordinates in determining the harvesting location of said food products.

6. The method of claim 5,
wherein in Step “A”, said plurality of food products are harvested by a food harvesting apparatus in a food growing field, and
wherein in Step “B”, said coordinates are associated with said plurality of food products by printing visually-identifiable longitudinal and latitudinal coordinates directly on each of said food products while said food harvesting apparatus is in said food growing field, such that said buyers can use said longitudinal and latitudinal coordinates in determining the harvesting location of said food products.

7. A method for providing source indication for food products harvested at a growing location including a growing space, distributed through a distribution network, and sold at multiple sales locations to corresponding multiple buyers, said method comprising the steps of:
A) providing a harvesting apparatus including a cut product station and at least one printer adjacent said cut product station:
B) moving said harvesting apparatus from a known geographic location at a known speed and direction;
C) tracking the geographic location of said harvesting apparatus;
D) defining a two dimensional virtual cut zone adjacent to and moving with said harvesting apparatus, said virtual cut zone being a zone in which at said food products are harvested relative to said harvesting apparatus as said harvesting apparatus is moving, such that the geographic coordinates of said cut zone are known relative to the geographic location of said harvesting apparatus as it moves;
E) harvesting said food products from their harvest location while in said virtual cut zone as said harvesting apparatus is moving and as the location of said virtual cut zone is known;
F) moving said products from said virtual cut zone to said cut product station of said harvesting apparatus; and
G) printing, with the printer provided in Step “A”, geographic coordinate related indicia corresponding to the location of said cut zone at the time said food products were harvested, and associating said indicia with said plurality of food products in a manner such that said indicia may be read by each of said buyers, in order to determine said harvest location of each of said plurality of food products.

8. The method of claim 7,
wherein in step “G”, said geographic coordinate related indicia is in the form of longitudinal and latitudinal coordinates printed on the packaging of each of said food products, such that said buyers can use said longitudinal and latitudinal coordinates in determining the harvesting location of said food products.

9. The method of claim 7, wherein in step “G”, said geographic coordinate related indicia is in the form of longitudinal and latitudinal coordinates printed directly on each of said food products, such that said buyers can use said longitudinal and latitudinal coordinates in determining the harvesting location of said food products.

10. The method of claim 7, wherein in step “G”, the “cut to print time”, that being the average time taken from when the food products are harvested to the time their geographic coordinate related indicia is associated therewith, is taken into account.

11. The method of claim 10, wherein in step “G”, the “cut to print time” can be varied as needed to accommodate various harvesting conditions.

12. The method of claim 11, wherein in step “C”, said “two dimensional virtual cut zone” can be varied as needed in one or both dimensions to accommodate various harvesting conditions.

13. The method of claim 7, wherein in step “C”, said “two dimensional virtual cut zone” can be varied as needed in one or both dimensions to accommodate various harvesting conditions.

14. The method of claim 7,
wherein in step “B”, said harvesting apparatus is moved by being towed by a tractor configured for moving at a known speed and direction through said growing space, said tractor including a tractor location data device, said tractor location data device configured for tracking location specific geographic coordinates of said tractor as said tractor moves across said growing space, and wherein the geographic location of said harvesting apparatus is known by comparing the relative positions of said harvesting apparatus and said tractor.

15. The method of claim 7,
wherein in Step “E”, said harvesting of said plurality of discrete food products from a corresponding plurality of different known geographic locations is done at a corresponding plurality of known harvesting times, and
wherein in Step “B”, said known harvesting times are associated along with said geographic coordinates with said plurality of food products in a manner such that said times and coordinates may be read by each of said buyers, in order to determine said harvesting location and time of each of said plurality of food products.

16. The method of claim 15,
wherein in step “G”, said geographic coordinate related indicia is in the form of longitudinal and latitudinal coordinates printed on the packaging of each of said food products, such that said buyers can use said longitudinal and latitudinal coordinates in determining the harvesting location of said food products.

17. The method of claim 15, wherein in step “G”, said geographic coordinate related indicia is in the form of longitudinal and latitudinal coordinates printed directly on each of said food products, such that said buyers can use said longitudinal and latitudinal coordinates in determining the harvesting location of said food products.

18. The method of claim 15, wherein in step “G”, the “cut to print time”, that being the average time taken from when the food products are harvested to the time their geographic coordinate related indicia is associated therewith, is taken into account.

19. The method of claim 18, wherein in step “G”, the “cut to print time” can be varied as needed to accommodate various harvesting conditions.

20. A system for providing source indication for food products first harvested at a growing location including a growing space, then distributed through a distribution network, and finally sold at multiple sales locations to corresponding multiple buyers, said system including:
a tractor for moving at a known speed and direction through said growing space, said tractor including a tractor data device, said tractor location data device configured for tracking location specific geographic coordinates of said tractor as said tractor moves across said growing space;
a harvesting apparatus configured to be pulled behind said tractor while said food products are harvested adjacent thereto, said harvesting apparatus including at least one printer configured to print tracking location specific geographic coordinate data associated with the harvest location of said food products, said printing being done in the form of indicia printed on labels configured to be applied to corresponding said food products; and
a control device having a data link with said tractor and a data link with said at least one printer, said control device configured to cause said printer to print said indicia such that said labels may be placed upon said food products and said coordinate data may be read by each of said buyers.

21. The system of claim 20, wherein said control device includes a computer including a processor and memory.
